(19) United States
(12) Patent Application Publication
(10) Pub. No.: US 2019/0185362 A1
(43) Pub. Date: Jun. 20, 2019

(54) BENDING DEVICE

(71) Applicant: SAKAI DISPLAY PRODUCTS CORPORATION, Sakai-shi, Osaka (JP)

(72) Inventor: Hiroki FUKAI, Sakai-shi (JP)

(73) Assignee: Sakai Display Products Corporation, Sakai-shi, Osaka (JP)

(21) Appl. No.: 16/309,084

(22) PCT Filed: Jun. 17, 2016
(86) PCT No.: PCT/JP2016/068139

§ 371 Date: Feb. 26, 2019

(51) Int. Cl. C03B 23/023

(52) U.S. Cl. CPC C03B 23/023

(57) ABSTRACT

Provided is a bending device of a simple configuration with which it is possible to perform bending processing while suppressing damage to the material being bent. The bending device 1 is equipped with a base portion 11 having an arcuate cross-section and having a moving surface 11a on which a material to be bent P is moved along the circumferential direction, and a plurality of bend correction plates 12 arranged to face the moving surface 11a with a predetermined distance therebetween and lined up side by side along the moving direction D of the material to be bent P.

### TECHNICAL FIELD

The present invention relates to a bending device for bending a material to be bent such as a glass sheet.

### BACKGROUND ART

In recent years, demand for a curved-surface display in which a display surface is curved has been increasing due to factors such as design appeal or a need to provide for curved-surface parts such as column-shaped parts and corners of cars. Liquid-crystal display panels are often used as this type of curved-surface display.

A liquid-crystal display panel for example includes: a glass substrate with a color filter, a counter electrode, and the like (CF substrate); a glass substrate with a plurality of pixel electrodes, thin-film transistors, and the like (TFT substrate): and a liquid-crystal layer enclosed between the CF substrate and the TFT substrate. When implementing a curved-surface display using a liquid-crystal display panel, bending is performed on the liquid-crystal display panel (glass substrates) so as to give the display panel a desired curvature. In this case, however, stress may be locally concentrated to damage the glass substrates.

For example, Patent Literature 1 discloses a bending device including an oven, a curving form, and a tempering section. The curving form has a plurality of curved rods, with each rod rising in an arrangement that is inclined at a predetermined angle relative to a horizontal plane. A glass sheet conveyed into the curving form is bent according to the inclination of the rods. The bent glass sheet then undergoes tempering.

### CITATION LIST

### Patent Literature

[Patent Literature 1]

Japanese Examined Patent Publication No. S62-022930

### SUMMARY OF INVENTION

### Technical Problem

However, the bending device according to Patent Literature 1 requires a heater to heat glass to a softening point and a metal mold to withstand high temperature, and is therefore a large-scale device. The bending device is also difficult to apply to mass-produced goods such as display panels due to an increase in volume of the processed glass in conveyance of the glass to an assembly section.

The present invention takes these circumstances into account and aims to provide a bending device of a simple configuration with which it is possible to perform bending processing on a material being bent while suppressing damage to the material being bent.

### Solution to Problem

The bending device according to the present invention includes a base portion and a plurality of bend correction plates. The base portion has a movement surface on which a material to be bent is moved in a circumferential direction of the movement surface. The movement surface has an arcuate cross-section. The bend correction plates are arranged to face the movement surface with a predetermined distance therebetween and lined up side by side along a movement direction of the material to be bent.

### Advantageous Effects of Invention

According to the present invention, a bending device of a simple configuration is provided with which it is possible to perform bending processing on a material being bent while suppressing damage to the material being bent.

### BRIEF DESCRIPTION OF DRAWINGS

FIG. 1 is a schematic perspective view of a bending device according to a first embodiment.

FIG. 2 is a schematic side view of the bending device according to the first embodiment.

FIG. 3A is a descriptive diagram for illustrating a method of bending a glass sheet P.

FIG. 3B is a descriptive diagram for illustrating the method of bending the glass sheet P.

FIG. 3C is a descriptive diagram for illustrating the method of bending the glass sheet P.

FIG. 4 is a schematic perspective view of a bending device according to a second embodiment.

FIG. 5 is a schematic sectional side view for illustrating pivoting of a bend correction plate with movement of a glass sheet P.

FIG. 6 is a schematic sectional side view of a bending device according to a third embodiment.

FIG. 7 is a schematic perspective view of the bending device according to the third embodiment.

### DESCRIPTION OF EMBODIMENTS

The following specifically describes embodiments of the present invention according to the accompanying drawings.

### First Embodiment

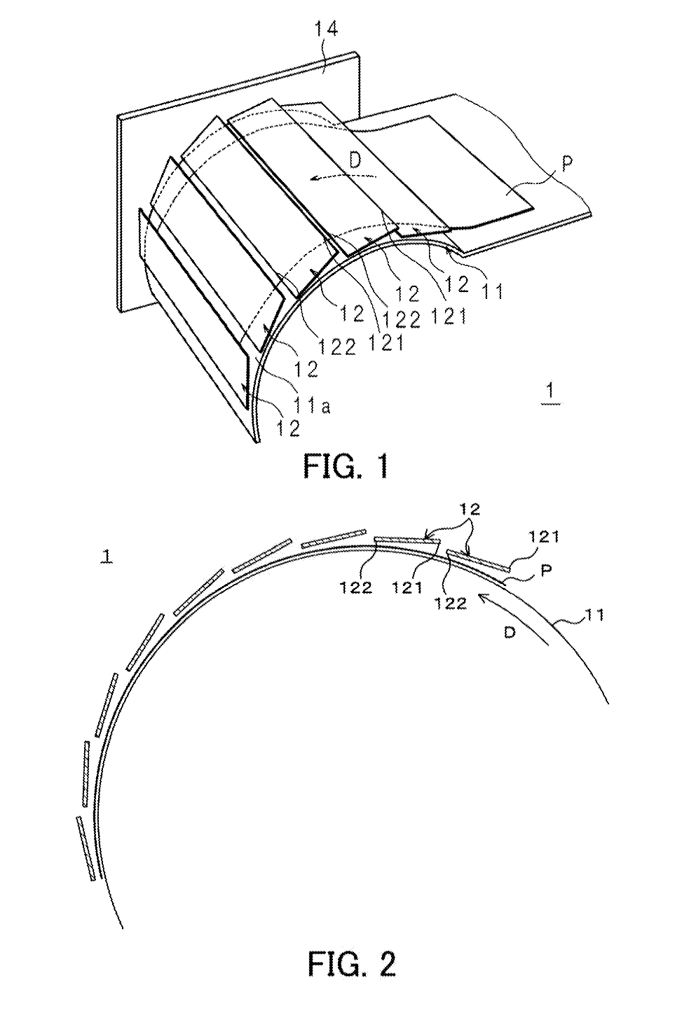

FIG. 1 is a schematic perspective view of a bending device 1 according to a first embodiment. FIG. 2 is a schematic side view of the bending device 1 according to the first embodiment.

The bending device 1 includes a base portion 11, a plurality of bend correction plates 12, and two side plates 14. The base portion 11 has an arcuate cross-section. An outer circumferential surface of the base portion 11, which is a surface having an arcuate cross-section, is a movement surface 11a on which a glass sheet P serving as a material to be bent is moved in a circumferential direction of the movement surface 11a. The side plates 14 are respectively mounted on either side of the movement surface 11a in a width direction (direction intersecting with a movement direction D of the glass sheet P on the movement surface 11a) thereof. In FIG. 1, illustration of a side plate 14 on a near side in FIG. 1 is omitted.

The bend correction plates 12 are arranged to face the movement surface 11a with a predetermined distance therebetween and lined up side by side along the movement direction D of the glass sheet P, which is the circumferential direction of the movement surface 11a. Each bend correction plate 12 is a rectangular plate-shaped member that is elongated in one direction, and is arranged such that a longitudinal direction thereof corresponds to the width direction of the movement surface 11a. A dimension of each bend correction plate 12 in the longitudinal direction thereof is substantially the same as a dimension of the movement surface 11a in the width direction thereof. The side plates 14 respectively support either end portion of each bend correction plate 12 in the direction intersecting the movement direction D, which is the longitudinal direction of the bend correction plate 12.

The bend correction plate 12 has an edge portion (referred to as a first edge portion in the following) 121 upstream in the movement direction D and an edge portion (referred to as a second edge portion in the following) 122 downstream in the movement direction D. According to the present embodiment, the bend correction plate 12 is fixed to the side plates 14 in a state where the first edge portion 121 is more separated from the movement surface 11a than the second edge portion 122. That is, the bend correction plate 12 is fixed to the side plates 14 in an inclined state such that the distance between the bend correction plate 12 and the movement surface 11a gradually becomes smaller from upstream to downstream in the movement direction D.

It is preferable to use highly rigid material in the base portion 11 and the bend correction plate 12. It is also preferable for surfaces making contact with the glass sheet P, which are the movement surface 11a of the base portion 11 and a surface of the bend correction plate 12 (referred to as an opposing surface in the following) facing the movement surface 11a, to be smooth. According to the present embodiment, bending is performed on the glass sheet P by inserting the glass sheet P so as to slide between the base portion 11 and the bend correction plate 12 and moving the glass sheet P between the base portion 11 and the bend correction plate 12 as illustrated in FIG. 2.

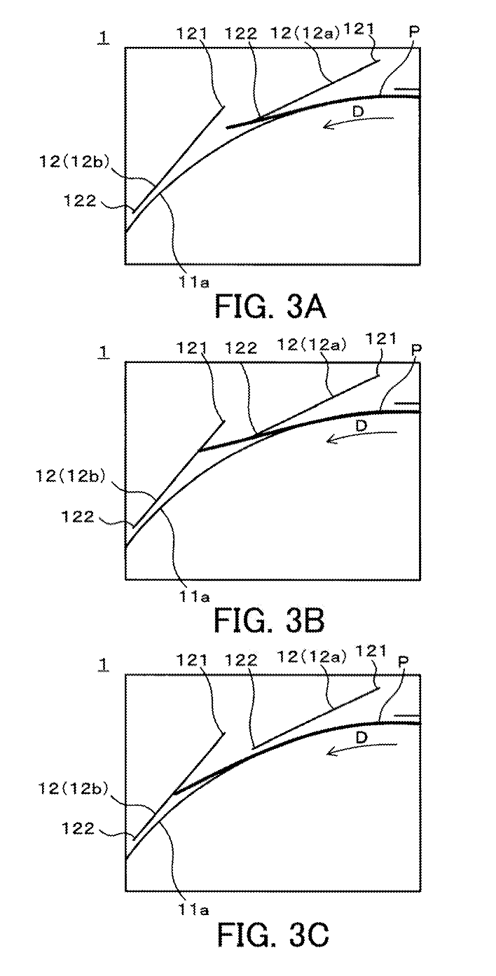

FIGS. 3A to 3C are descriptive diagrams for illustrating a method of bending the glass sheet P. In FIGS. 3A to 3C, a bend correction plate 12a is a bend correction plate 12 positioned upstream in the movement direction D, and a bend correction plate 12b is a bend correction plate 12 positioned downstream in the movement direction D.

When the glass sheet P is moved from a state illustrated in FIG. 3A, the glass sheet P is kept pressed against the upstream bend correction plate 12a and a leading edge portion of the glass sheet P advances while touching the downstream bend correction plate 12b as illustrated in FIG. 3B. As a result, a part of the glass sheet P passing beneath the bend correction plates 12a and 12b is bent by being pressed against the base portion 11 as illustrated in FIG. 3C. As the glass sheet P advances, the glass sheet P is guided by the bend correction plates 12 and each part of the glass sheet P is gradually stressed and bent. Finally, the glass sheet P is deformed into a shape following the movement surface 11a by the entire glass sheet P passing the movement surface 11a of the base portion 11. As such, deforming stress can be evenly dispersed and stress concentration on the glass sheet P can be avoided by performing bending with the bending device 1 according to the present embodiment. Therefore, damage to the glass sheet P when bending the glass sheet P can be suppressed.

Note that lengthwise and widthwise dimensions, inclining angle, and number of bend correction plates 12 can be set to various values. For example, in a configuration using nine bend correction plates 12 to bend a 1.2 m long glass sheet P, the bend correction plates 12 are fixed to the side plates 14 so that for example a central portion in the movement direction D of each bend correction plate 12 is separated from the base portion 11 by a distance of approximately 20 mm. In this case, the widthwise dimension of the bend correction plate 12 is for example 12 cm, and the lengthwise dimension of the bend correction plate 12 is for example 1 m. The bend correction plates 12 are also arranged with a distance of for example approximately 10 cm therebetween.

### Second Embodiment

A bending device 21 according to a second embodiment has the same configuration as the bending device 1 according to the first embodiment aside from bend correction plates 12 being configured to be pivotable with centers thereof in a movement direction D as axes.

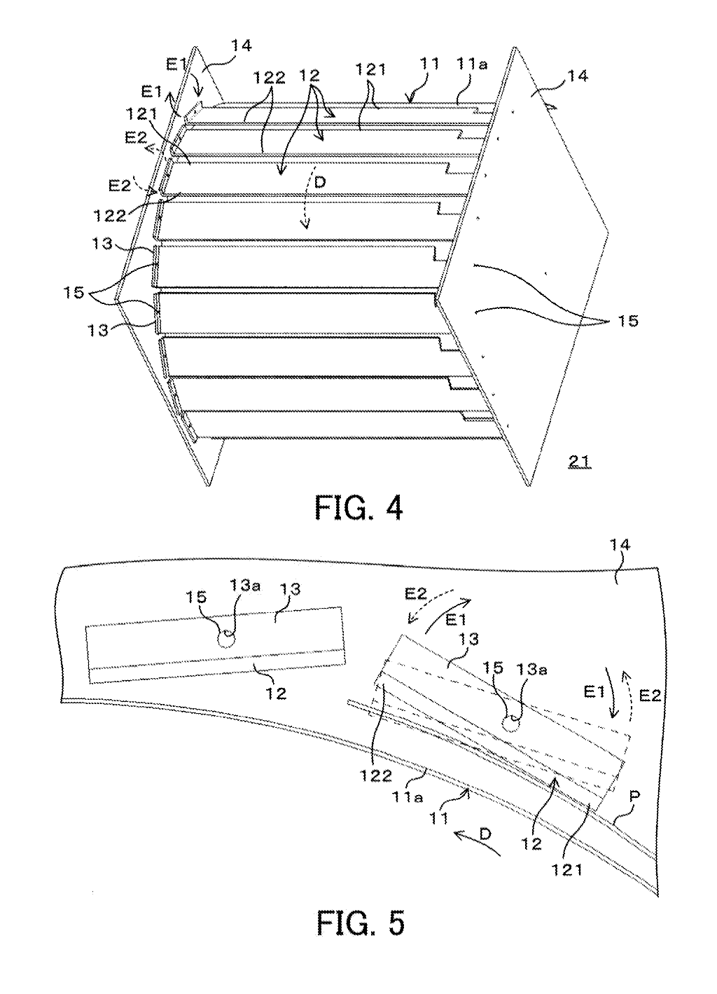

FIG. 4 is a schematic perspective view of the bending device 21 according to the second embodiment. Constituent elements shared with FIGS. 1 and 2 are labeled with the same reference signs and detailed description thereof is omitted.

In the bending device 21 according to the present embodiment, each bend correction plate 12 has a pair of pivot plates 13. The pivot plates 13 are respectively provided perpendicular to the bend correction plate 12 on either end portion of the bend correction plate 12 in a longitudinal direction (direction intersecting the movement direction D) of the bend correction plate 12. A pin hole 13a (refer to FIG. 5) is provided in a central portion of each pivot plate 13. By inserting a pin 15 through the pin hole 13a of each pivot plate 13 with play from an outer side of each side plate 14, the bend correction plate 12 is supported by the side plates 14 so as to be pivotable with the center thereof in the movement direction D as an axis. Therefore, the bend correction plate 12 is pivotable around the pins 15 in a first direction E1 and a second direction E2. The first direction E1 is a direction in which a first edge portion 121 of the bend correction plate 12 approaches the movement surface 11a and a second edge portion 122 of the bend correction plate 12 separates from the movement surface 11a. The second direction E2 is a direction in which the first edge portion 121 separates from the movement surface 11a and the second edge portion 122 approaches the movement surface 11a.

FIG. 5 is a schematic sectional side view for illustrating the pivoting of the bend correction plate 12 with the movement of a glass sheet P.

According to the present embodiment, the first edge portion 121 is more separated from the movement surface 11a than the second edge portion 122 before the glass sheet P passes between the bend correction plate 12 and the movement surface 11a as illustrated in FIG. 5. When the glass sheet P passes between the bend correction plate 12 and the movement surface 11a, a leading edge of the glass sheet P first makes contact with an opposing surface of the bend correction plate 12. Thereafter, the bend correction plate 12 pivots in the first direction E1 as the leading edge of the glass sheet P advances along the opposing surface of the bend correction plate 12. Therefore, load on the glass sheet P from the bend correction plate 12 can be lessened, and the glass sheet P can be favorably deformed into a shape following the movement surface 11a while suppressing localized stress from being applied to the glass sheet P. Therefore, damage to the glass sheet P when bending the glass sheet P can be further suppressed. According to the present embodiment, stress is favorably reduced by the pivoting of the bend correction plate 12 even when a movement speed of the glass sheet P is increased.

### Third Embodiment

A bending device 31 according to a third embodiment has the same configuration as the bending device 21 according to the second embodiment aside from that an inclining angle θ of each bend correction plate 12 with respect to a movement surface 11a (simply referred to as an inclining angle θ of the bend correction plate 12 in the following) can be set to a desired angle.

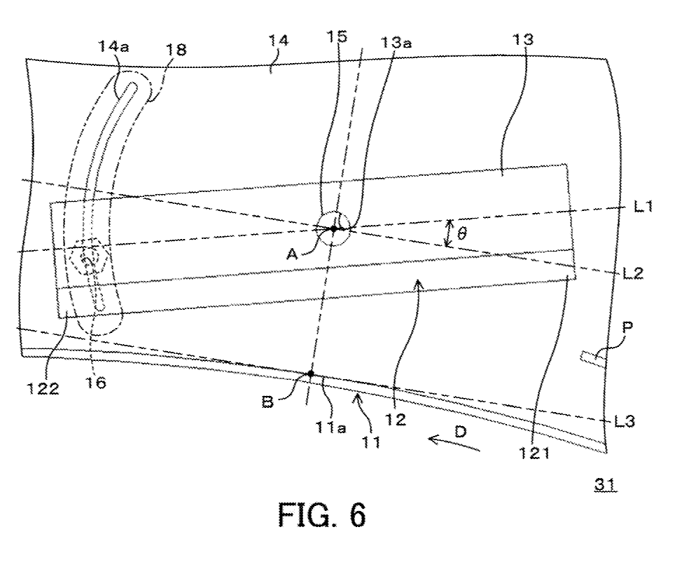

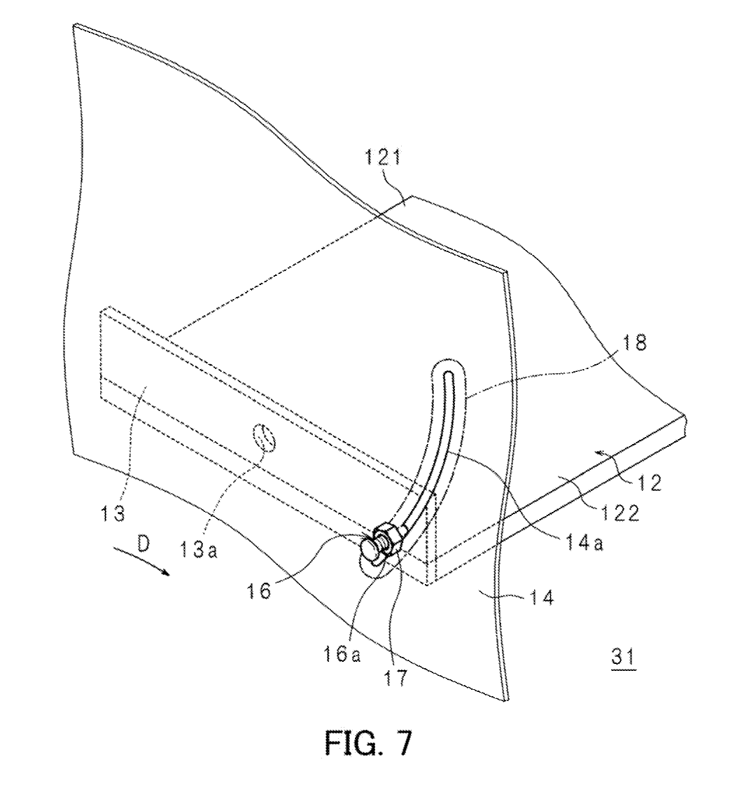

FIG. 6 is a schematic sectional side view of the bending device 31 according to the third embodiment. FIG. 7 is a schematic perspective view of the bending device 31 according to the third embodiment. Constituent elements shared with FIGS. 4 and 5 are labeled with the same reference signs and detailed description thereof is omitted.

The bending device 31 according to the present embodiment includes an inclining angle adjustment mechanism 18 for adjusting the inclining angle θ of the bend correction plate 12 to a desired angle. Note that in FIG. 6, the inclining angle θ of the bend correction plate 12 is shown as a reference of a tangent line L3 at a point B. Herein, a point A is the center of a pin 15, which is the center of a pivoting axis of the bend correction plate 12, and the point B is an intersection of the movement surface 11a and a line passing though the point A and the center of an arc formed by the movement surface 11a. A line L1 passes through the point A and extends in the same direction as an opposing surface of the bend correction plate 12. A line L2 passes through the point A and is parallel to the tangent line L3. The inclining angle adjustment mechanism 18 includes a protrusion 16 provided on at least one of either end portion of the bend correction plate 12 in a longitudinal direction thereof, a guide hole 14a formed in at least one of a pair of side plates 14, and a nut 17 (fastening member) which fixes pivoting of the bend correction plate 12 by being fastened to the protrusion 16.

The protrusion 16 is provided on at least one of pivot plates 13 of the bend correction plate 12 so as to protrude outward. Specifically, the protrusion 16 is provided in a position near a first edge portion 121 or a second edge portion 122 on an outer surface (surface not facing another pivot plate 13) of one of the pair of pivot plates 13 so as to protrude perpendicularly outward from the surface.

The guide hole 14a is arcuate for example. The guide hole 14a receives insertion of the protrusion 16 and guides movement of the protrusion 16 as the bend correction plate 12 pivots. A plurality of guide holes 14a respectively corresponding to protrusions 16 of a plurality of bend correction plates 12 are formed in at least one of the side plates 14. In a configuration in which a protrusion 16 is provided on one of each pair of pivot plates 13, the guide holes 14a are formed in one of the side plates 14 that is located toward the pivot plate 13 provided with the protrusion 16. In a configuration in which a protrusion 16 is provided on both of each pair of pivot plates 13 by contrast, the guide holes 14a are formed in both of the side plates 14.

A tip of the protrusion 16 protrudes outward from the guide hole 14a, and a male screw 16a is provided on a protruding part of the protrusion 16. The pivoting of the bend correction plate 12 is fixed by fitting the nut 17 to the tip of the protrusion 16 inserted through the guide hole 14a.

According to the present embodiment, the bend correction plate 12 is rotated around the pins 15 to a position that allows the inclining angle θ of the bend correction plate 12 to be a desired angle, with a base part of the protrusion 16 inserted through the guide hole 14a. Thereafter, the bend correction plate 12 is fixed to a side plate 14 by fastening the nut 17 to the male screw 16a. Therefore, in the bending device 31 according to the present embodiment, the inclining angle θ of each bend correction plate 12 can be easily set to a desired angle.

It should be noted here that the way that stress is applied to the glass sheet P when bending varies according to the inclining angle θ of the bend correction plate 12. Also, rigidity of the glass sheet P varies according to thickness, size, or the like of the glass sheet P. Therefore, an optimal inclining angle θ of the bend correction plates 12 varies according to the type of the glass sheet P intended for bending. According to the present embodiment, however, the inclining angle θ of the bend correction plates 12 can be easily set to an optimal angle for the intended glass sheet P.

Note that the present embodiment is described using an example in which the protrusion 16 is fixed by the nut 17. However, the present embodiment is not limited as such, and the protrusion 16 may be fixed by securing the base part of the protrusion 16 to the guide hole 14a after positioning the bend correction plate 12. Another configuration is possible in which the base part of the protrusion 16 is not secured to the guide hole 14a but rather the base part of the protrusion 16 moves along the guide hole 14a with the pivoting of the bend correction plate 12.

A number of embodiments of the present invention are described above. As such, a bending device 1 (21, 31) according to the embodiments includes a base portion 11 and a plurality of bend correction plates 12. The base portion 11 has a movement surface 11a which is a surface having an arcuate cross-section. A material P to be bent is moved along the movement surface 11a in a circumferential direction of the movement surface 11a. The bend correction plates 12 are arranged to face the movement surface 11a with a predetermined distance therebetween and lined up side by side along a movement direction D of the material P to be bent.

According to the above configuration, deforming stress applied to the material P to be bent when bending can be evenly dispersed, and stress concentration in a glass sheet P can be prevented. Therefore, damage to the material P to be bent when bending can be suppressed. Accordingly, in the bending device 1 according to the embodiments, bending can be performed while suppressing damage to the material P to be bent with a simple configuration such as the above.

In the bending device 1 according to the embodiments, a first edge portion 121 of each bend correction plate 12 upstream in the movement direction D may be more separated from the movement surface 11a than a second edge portion 122 of each bend correction plate 12 downstream in the movement direction D.

According to the above configuration, a leading edge of the material P to be bent can be easily inserted to slide between the movement surface 11a and a bend correction plate 12. Therefore, it is possible to prevent a problem of damage being caused to the material P to be bent due to the material P to be bent hitting the first edge portion 121 of the bend correction plate 12 or the material P to be bent failing to slide between the movement surface 11a and the bend correction plate 12 and bending backward.

In the bending device 1 according to the embodiments, the bend correction plate 12 may be pivotable in a first direction E1 and a second direction E2. The first direction E1 is a direction in which the first edge portion 121 upstream in the movement direction D approaches the movement surface 11a and the second edge portion 122 downstream in the movement direction D separates from the movement surface 11a.

The second direction E2 is a direction in which the first edge portion 121 separates from the movement surface 11a and the second edge portion 122 approaches the movement surface 11a.

According to the above configuration, load on the material P to be bent from the bend correction plate 12 can be lessened, and the material P to be bent can be favorably deformed into a shape following the movement surface 11a while suppressing localized stress from being applied to the material P to be bent. Therefore, damage to the material P to be bent when bending can be further suppressed. Also, stress is favorably reduced by the pivoting of the bend correction plate 12 even when the movement speed of the material P to be bent is increased.

In the bending device 1 according to the embodiments, the first edge portion 121 is more separated from the movement surface 11a than the second edge portion 122 before the material P to be bent passes between the bend correction plate 12 and the movement surface 11a, and the bend correction plate 12 may pivot in the first direction E1 when the leading edge of the material P to be bent passes between the bend correction plate 12 and the movement surface 11a.

According to the embodiments, the bending device 1 may further include an inclining angle adjustment mechanism 18 for adjusting an inclining angle θ of the bend correction plate 12 with respect to the movement surface 11a to a desired angle.

According to the above configuration, the inclining angle θ of the bend correction plate 12 can be easily set to a desired angle. Therefore, the inclining angle θ of the bend correction plate 12 can be easily set to an optimal angle for the glass sheet P intended for bending.

According to the embodiments, the bending device 1 may further include a pair of side plates 14 respectively supporting either end portion of the bend correction plate 12 in a direction intersecting with the movement direction D such that the bend correction plate 12 is pivotable in the first direction E1 and the second direction E2. The first direction E1 is a direction in which the first edge portion 121 upstream in the movement direction D approaches the movement surface 11a and the second edge portion 122 downstream in the movement direction D separates from the movement surface 11a. The second direction E2 is a direction in which the first edge portion 121 separates from the movement surface 11a and the second edge portion 122 approaches the movement surface 111a. The inclining angle adjustment mechanism 18 may include a protrusion 16, a guide hole 14a, and a fastening member 17. The protrusion 16 is provided on at least one of the end portions of the bend correction plate 12 so as to protrude outward. The guide hole 14a is a hole formed in at least one of the side plates 14 for receiving insertion of the protrusion 16 and guiding the movement of the protrusion 16 as the bend correction plate 12 pivots. The fastening member 17 fixes the pivoting of the bend correction plate 12 by being fastened to the protrusion 16.

According to the above configuration, the bend correction plate 12 is rotated with a center thereof in the movement direction D as an axis to a position that allows the inclining angle θ of the bend correction plate 12 to be a desired angle, with the protrusion 16 inserted through the guide hole 14a. Thereafter, the bend correction plate 12 is fixed to side plate 14 by fastening the fastening member 17 to the protrusion 16. Thus, the bend correction plate 12 can be favorably inclined.

Note that the presently disclosed embodiments are merely examples in all respects and should not be construed to be limiting. The scope of the present invention is indicated by the claims, rather than by the description given above, and includes all variations that are equivalent in meaning and scope to the claims.

### REFERENCE SIGNS LIST

1, 21, 31 Bending device
11 Base portion
11a Movement surface
12 Bend correction plate
121 First edge portion
122 Second edge portion
13 Pivot plate
13a Pin hole
14 Side plate
14a Guide hole
15 Pin
16 Protrusion
16a Male screw
17 Nut
18 Inclining angle adjustment mechanism

1. A bending device comprising:
a base portion having a movement surface on which a material to be bent is moved in a circumferential direction of the movement surface, the movement surface having an arcuate cross-section; and
a plurality of bend correction plates arranged to face the movement surface with a predetermined distance therebetween and lined up side by side along a movement direction of the material to be bent.

2. The bending device according to claim 1, wherein
each of the bend correction plates has a first edge portion upstream in the movement direction and a second edge portion downstream in the movement direction, the first edge portion being more separated from the movement surface than the second edge portion.

3. The bending device according to claim 1, wherein
each of the bend correction plates is pivotable in a first direction and a second direction,
the first direction is a direction in which a first edge portion of the bend correction plate upstream in the movement direction approaches the movement surface and a second edge portion of the bend correction plate downstream in the movement direction separates from the movement surface, and
the second direction is a direction in which the first edge portion separates from the movement surface and the second edge portion approaches the movement surface.

4. The bending device according to claim 3, wherein
the first edge portion is more separated from the movement surface than the second edge portion before the material to be bent passes between the bend correction plate and the movement surface, and
the bend correction plate pivots in the first direction when a leading edge of the material to be bent passes between the bend correction plate and the movement surface.

5. The bending device according to claim 1, further comprising
an inclining angle adjustment mechanism configured to adjust an inclining angle of each of the bend correction plates with respect to the movement surface to a desired angle.

6. The bending device according to claim 5, further comprising
a pair of side plates respectively supporting either end portion of each of the bend correction plates in a direction intersecting the movement direction such that the bend correction plate is pivotable in a first direction and a second direction, wherein
the first direction is a direction in which a first edge portion of the bend correction plate upstream in the movement direction approaches the movement surface and a second edge portion of the bend correction plate downstream in the movement direction separates from the movement surface,
the second direction is a direction in which the first edge portion separates from the movement surface and the second edge portion approaches the movement surface, and
the inclining angle adjustment mechanism includes:
a protrusion provided on at least one of the end portions of the bend correction plate so as to protrude outward;
a guide hole formed in at least one of the side plates, and configured to receive insertion of the protrusion and guide movement of the protrusion as the bend correction plate pivots; and
a fastening member configured to fix pivoting of the bend correction plate by being fastened to the protrusion.
